(19) United States
(12) Patent Application Publication
(10) Pub. No.: US 2023/0354844 A1
(43) Pub. Date: Nov. 9, 2023

(54) PLANT-BASED CHOCOLATE

(71) Applicant: THE HERSHEY COMPANY, Hershey, PA (US)

(72) Inventor: Xiaoying WANG, Hummelstown, PA (US)

(73) Assignee: THE HERSHEY COMPANY, Hershey, PA (US)

(21) Appl. No.: 18/246,012

(22) PCT Filed: Sep. 21, 2021
(86) PCT No.: PCT/IB2021/058590

§ 371 Date: Mar. 20, 2023

Related U.S. Application Data
(60) Provisional application No. 63/083,350, filed on Sep. 25, 2020.

(51) Int. Cl. A23G 1/48; A23G 1/40; A23G 1/36

(52) U.S. Cl. CPC A23G 1/48; A23G 1/40; A23G 1/36

(57) ABSTRACT

A dairy-free, gluten free and vegan chocolate confection and method of making the same are disclosed. In the chocolate confection of the invention, the milk solids present in traditional milk chocolate are replaced by heat-treated legume flour. The heat-treated legume flour imparts desirable flavor and texture characteristics to the chocolate confection. The legume flours have relatively low levels of sugar and high levels of protein and fiber. They are also suitable for reduced-sugar chocolate formulations.

### FIELD OF THE INVENTION

This application is directed to the manufacture of confectionery products and more particularly to the manufacture of plant-based chocolate using heat-treated bean or pea flour as a replacement for dairy ingredients.

### BACKGROUND OF THE INVENTION

The recognition of the benefits of, and consumer preferences for, vegan, dairy free and gluten free diets are on the rise. Lactose, a sugar found in dairy, has long been recognized as problematic for some individuals. Many children under the age of 18 suffer from food allergies. There are reports of significant improvements of children's sleep patterns, behavior, language, focus and eye contact when allergy prone foods are removed from the diet.

Those with dairy intolerances usually fall into one of two groups: either lactose intolerance or casein sensitivity. It is estimated that between 30-50 million Americans are lactose intolerant. Certain ethnic and racial populations are more affected than others. For example, almost all Asians are lactose intolerant. Lactose intolerance is the inability to digest significant amounts of lactose, the major sugar found in dairy products/milk. Lactose intolerance is caused by a shortage of the enzyme lactase, which is produced by the cells that line the small intestine. Lactase is responsible for breaking milk sugar into two simpler forms of sugar called glucose and galactose which are then absorbed into the blood stream. Symptoms can be controlled through diet by limiting their lactose ingestion. People differ in the amounts and types of foods they can tolerate. Researchers have identified a genetic link for lactose intolerance. Casein is one of the primary proteins in cow's milk and like lactose intolerance, individuals differ in the amount of casein they can tolerate.

Individuals who must avoid milk due to an allergy, lactose intolerance, or as part of a vegan diet will need to eliminate milk chocolate. Many of these individuals desire a product with the same taste and pleasing mouthfeel as milk chocolate but without the dairy ingredients. To date, the confectionery industry has been unsuccessful in meeting consumer expectations in this regard.

Traditional chocolate making methods are well known and involve several basic steps carried out in a particular order. Generally, the process starts with cocoa beans harvested from pods of fruit that grow on the cacao tree. The cocoa beans are removed from the pods and placed in large piles to ferment, during which the shells of the beans harden and darken, and a rich cocoa flavor develops.

Dried cocoa beans are heat-treated at very high temperatures and hulled to separate the shell from the inside of the bean, also called a “nib,” the part of the bean used to make chocolate. The nibs are milled by a grinding process that turns the nibs into a liquid called chocolate liquor. The chocolate liquor, which may be separated in advance into its constituents, cocoa butter and cocoa powder, is mixed with a sweetener, usually sugar, and in the case of milk chocolate, milk solids are also added.

The mixture is refined and then conched, a process in which the chocolate powder is maintained above the fat melting temperature while mixing elements smooth out gritty particles, remove moisture and off-flavors, and develop pleasant flavors. Conching also releases fat, increasing fat coating on particles so that the chocolate has a proper fluidity for further processing. Additional fat is added to achieve the full formulated fat content and emulsifiers are also added to reduce viscosity and enhance fluidity of the chocolate paste. The liquid chocolate paste is tempered and then poured or deposited into a mold to produce a chocolate bar or used for enrobed products.

Consumers with allergies to dairy ingredients, or who otherwise desire to exclude dairy and/or animal-based ingredients from their diets seek a chocolate confection that does not contain the milk solids present in milk chocolates made according to the traditional method. These consumers seek a chocolate confection that possesses many of the same tastes, mouth feel and properties of traditional milk chocolate but without dairy or animal products. Chocolate manufacturers seeking to produce dairy-free chocolate confections require a product that has favorable processability and rheological properties similar to milk chocolate. The ingredients for producing such dairy free confections must also be readily available and cost effective.

Others have used solids derived from nuts and oil seeds as a replacement for milk solids to produce vegan and dairy free chocolate confections. Incorporation of these replacement solids, however, has not been very successful in commercial products since they have a negative impact on the texture and mouthfeel of the chocolate. Confections comprising solids derived from nuts and oil seeds are typically dry, chewy and slow to melt in the mouth. Similarly, the use of legume flour and syrup solids derived from legume are also seen in existing chocolate confections. These ingredients also negatively impact the mouthfeel of the chocolate confections in a similar way as solids from oil seeds and nuts.

Accordingly, there is a need for a dairy-free, plant-based chocolate confection that possesses the taste, texture and feel of a typical milk chocolate, is economical to produce, and has favorable processability and rheological properties when compared to existing dairy-free “milk” chocolate confections.

### SUMMARY

In general terms, the present disclosure is directed to a dairy-free substitute for the nonfat dairy solids normally used in the manufacture of milk chocolate, methods of producing dairy-free chocolate confections, and the confections themselves. In a chocolate confection that ordinarily contains nonfat milk solids, a dairy free substitute of this disclosure can replace some or all of the nonfat milk solids in the confection.

According to aspects of the present disclosure, heat-treated legume flour, such as precooked (pre-gelled) navy bean flour or chick pea flour is used as a replacement for dairy ingredients in milk chocolate formulations. The heat-treated legume flour is preferably used in a chocolate confection in place of nonfat milk solids. It has been unexpectedly discovered that substituting heat-treated legume flour for milk solids in a typical milk chocolate confection formulation provides a texture, mouthfeel, processability and flavor as pleasant as traditional milk chocolate, more so than other known substitutions, including legume flour that has not been heat-treated.

According to aspects of this disclosure, an edible, dairy-free chocolate confection is described, comprising heat-treated legume flour, a cocoa component, a sweetener, and a plant origin fat.

Aspect 1: A chocolate confection comprising:
a heat-treated legume flour component;
a cocoa component;
a sweetener; and
a plant origin fat.

Aspect 2: The chocolate confection of Aspect 1, wherein the chocolate confection is dairy-free.

Aspect 3: The chocolate confection of any of Aspects 1-2, wherein the heat-treated legume flour component comprises a legume flour selected from the group consisting of beans, peas, chickpeas and combinations thereof.

Aspect 4: The chocolate confection of any of Aspects 1-3, wherein the cocoa component is selected from the group consisting of cocoa solids, cocoa powder, cocoa liquor and combinations thereof.

Aspect 5: The chocolate confection of any of Aspects 1-4, wherein the sweetener is a nutritive sweetener selected from the group consisting of sucrose, fructose, glucose, corn syrup solids and combinations thereof.

Aspect 6: The chocolate confection of any of Aspects 1-5, wherein the sweetener comprises a sweetener selected from the group consisting of sugar alcohols, rare sugars, intensity sweeteners and combinations thereof.

Aspect 7: The chocolate confection of any of Aspects 1-6, wherein the plant origin fat is selected from the group consisting of cocoa butter, palm oil, palm kernel oil, sunflower oil, shea, sal, illepe, coconut and combinations thereof.

Aspect 8: The chocolate confection of any of Aspects 1-7, wherein the heat-treated legume flour component is selected from the group consisting of chickpeas, navy beans and combinations thereof.

Aspect 9: The chocolate confection of any of Aspects 1-8, wherein the heat-treated legume flour component comprises less than 5 percent by weight of water.

Aspect 10: The chocolate confection of any of Aspects 1-9, wherein the sweetener is a nutritive sweetener and the heat-treated legume flour component comprises from 4 to 40 percent by weight of the chocolate confection.

Aspect 11: The chocolate confection of any of Aspects 1-10, wherein the sweetener is a nutritive sweetener and the heat-treated legume flour component comprises from 8 to 25 percent by weight of the chocolate confection.

Aspect 12: The chocolate confection of any of Aspects 1-11, wherein the sweetener comprises from 20 to 60 percent by weight of the chocolate confection.

Aspect 13: The chocolate confection of any of Aspects 1-12, wherein the plant origin fat comprises from 10 to 40 percent by weight of the chocolate confection.

Aspect 14: The chocolate confection of any of Aspects 1-13, wherein the cocoa component comprises from 15 to 40 percent by weight of the chocolate confection.

Aspect 15: The chocolate confection of any of Aspects 1-14, wherein the heat-treated legume flour component comprises from 12 to 20 percent by weight of the chocolate confection.

Aspect 16: The chocolate confection of any of Aspects 1-15, wherein the sweetener comprises from 40 to 55 percent by weight of the chocolate confection.

Aspect 17: The chocolate confection of any of Aspects 1-16, wherein the cocoa component comprises from 15 to 30 percent by weight of the chocolate confection.

Aspect 18: The chocolate confection of any of Aspects 1-17, wherein the plant origin fat comprises from 15 to 25 percent by weight of the chocolate confection.

Aspect 19: A method of making a dairy-free chocolate confection comprising:
a. providing a heat-treated legume flour component; and
b. mixing and grinding a desired amount of the heat-treated legume flour component with a desired amount of a sweetener, a desired amount of a cocoa component, and a desired amount of a plant origin fat, a plant-origin fat to produce a dairy-free chocolate confection.

Aspect 20: The method of Aspect 19, wherein step b comprises mixing and grinding the heat-treated legume flour component in an amount of from 12 to 20 percent by weight of the chocolate confection.

Aspect 21: The method of any of Aspects 19-20, wherein step b comprises mixing and grinding the sweetener in an amount of from 40 to 55 percent by weight of the chocolate confection.

Aspect 22: The method of any of Aspects 19-21, wherein step b comprises mixing and grinding the cocoa component in an amount of from 15 to 30 percent by weight of the chocolate confection.

Aspect 23: The method of any of Aspects 19-22, wherein step b comprises mixing and grinding the a plant origin fat in an amount of from 15 to 25 percent of the chocolate confection.

Aspect 24: The method of any of Aspects 19-23, wherein step b comprises mixing and grinding the heat-treated legume flour with the sweetener, the cocoa component, and the plant origin fat until a target particle size of the heat-treated legume flour component is obtained.

### BRIEF DESCRIPTION OF THE DRAWINGS

For a more complete understanding of the present invention, reference is made to the following detailed description of an embodiment considered in conjunction with the accompanying drawings, in which:

FIG. 1 is a diagram showing the method of making a dairy-free chocolate confection according to an embodiment of the claimed invention.

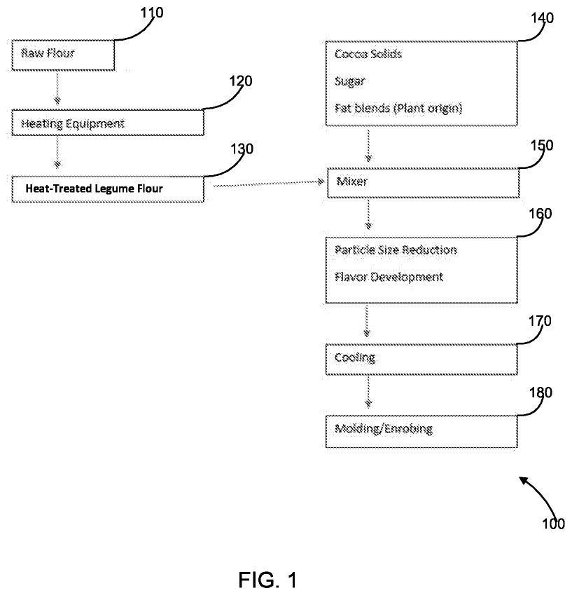

### DETAILED DESCRIPTION OF THE INVENTION

Disclosed herein are dairy-free chocolate confections wherein the milk solids present in standard milk chocolate have been replaced by heat-treated legume flour. Methods of preparing the confections are also disclosed. It has been unexpectedly discovered that using heat-treated legume flour as a substitute for dairy solids produces chocolate confections with improved organoleptic and rheological properties over known dairy-free chocolates, including those containing legume flour that has not been heat-treated as a substitute for milk solids. The heat-treated legume flours confer other advantages, such as by providing fiber and protein while being relatively low in sugar.

The following disclosure is presented to provide an illustration of the general principles of the present invention and is not meant to limit, in any way, the inventive concepts contained herein. Moreover, the features described in this section can be used in combination with the other described features in each of the multitude of possible permutations and combinations contained herein.

All terms defined herein should be afforded their broadest possible interpretations, including any implied meanings as dictated by a reading of the specification as well as any words that a person having skill in the art and/or a dictionary, treatise, or similar authority would assign particular meaning. Further, it should be noted that, as recited in the specification and in the claims appended hereto, the singular forms “a,” “an,” and “the” include the plural referents unless otherwise stated. Additionally, the terms “comprises” and “comprising” when used herein specify that certain features are present in that embodiment, but should not be interpreted to preclude the presence or addition of additional features, components, operations, and/or groups thereof.

The following disclosure is intended to be read in connection with the accompanying drawings, which are to be considered part of the entire written description of the invention. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The term “legume flour” as used in the specification and claims refers to the powder made by milling or grinding raw legumes. The terms “legume flourthat has not been heat treated” and “raw legume flour” as used in the specification and claims refers to flour that has not been heat-treated, cooked or subjected to heat treatment other than the minimal heat treatment used by legume producers and flour mills to destroy pest organisms. The term “heat-treated legume flour” as used in the specification and claims refers to a raw legume flourthat has been processed through the application of direct or indirect heat sufficient to cause the legume flour to undergo a measurable change to at least one of moisture content, flavor or color. The heat-treating process partially gelatinizes the starches in the flour and, accordingly, the heat treated flour is also referred to herein as “pre-gelled” flour.

The term “dairy-free chocolate” as used in the specification and claims is intended to refer to a chocolate confection that is substantially free of dairy ingredients, or any other animal origin ingredients. The term “substantially free” as used in the specification and claims means less than 1 percent by weight.

The term “dairy ingredients” or “milk ingredients” as used in the specification refers to any dairy product (i.e., milk produced by a mammal) that is added to traditional milk chocolate. Examples of milk ingredients include, but are not limited to, nonfat milk solids, cream, milk fat (including anhydrous milk fat), milk (which may be concentrated, sweetened condensed, evaporated, dried), skim milk (which may be concentrated, sweetened condensed, evaporated, dried, nonfat), or buttermilk (concentrated or dried).

The term “milk chocolate” or “traditional milk chocolate” or “typical milk chocolate”, as used in the specification and claims, refers to a milk chocolate having diary ingredients.

The term “sweetener” as used in the specification and claims comprises nutritive sweeteners, including, but not limited to, sugar, dextrose, fruit sugar and the like. The term “sweetener” also comprises high potency nutritive sweeteners, low-calorie nutritive sweeteners and the like. The term “sweetener” also comprises non-nutritive sweeteners or a combination of nutritive and non-nutritive sweeteners.

The term “cocoa component” as used in the specification and claims refers to any ingredient obtained from a cocoa bean, including, but not limited to, cocoa liquor, cocoa powder, cocoa solids and combinations thereof. It is noted that some cocoa components, including cocoa powder and cocoa liquor, comprise cocoa butter in part, but in the formulations described herein, this cocoa butter constituent is treated as a cocoa component.

The terms “plant origin fat,” “plant-based fat,” vegetable oil” and “vegetable fat” as used in the specification and claims refer to any fat or oil extracted from seeds, nuts, fruits or vegetables, including cocoa butter. In the formulations described herein, where cocoa butter is used as the plant origin fat, it is in addition to any cocoa butter contained in the cocoa component.

The term “emulsifier,” as used in the specification and claims, is intended to refer to an ingredient that impacts fluidity of the milk chocolate.

The terms “flavor” and “flavorings” as used in the specification and claims, are intended to refer to any natural flavorings, excluding those flavors which alone or in combination mimic milk flavors or chocolate flavors.

The dairy-free chocolate confections of the claimed invention comprise a heat-treated legume flour component, a cocoa component, a sweetener and a plant origin fat. Other optional ingredients include flavorings and emulsifiers.

The Heat-Treated Legume Flour Component

The heat-treated legume flour component is made by heat treating a legume flour produced by milling a raw legume or heat-treating a legume first then making it into a powder. Preferred raw legumes used to create the heat-treated legume flour component include, but are not limited to beans, chickpeas, and peas. Preferred legume flours include chickpea and navy bean flours. A more preferred legume flour is chickpea flour. A preferred commercially available heat-treated legume flour is Pre-gelled Chick Pea Powder PCN 892001, available from ADM Edible Bean Specialties, Inc., Decatur, Illinois.

Preferably, the moisture content of the heat-treated legume flour is less than 12 percent by weight, more preferably, less than 10 percent by weight. Preferably, the protein content of the heat-treated legume flour ranges from 15 to 30 percent by weight of the flour, more preferably, from 20 to 25 percent by weight. Preferably, the fat content of the heat-treated legume flour is less than 15 percent by weight of the flour, more preferably, less than 10 percent by weight. Preferably, the carbohydrate content of the heat-treated legume flour ranges from 50 to 75 percent by weight of the flour, more preferably, from 60 to 70 percent by weight. The particle size of the heat-treated legume flour, as measured by pass-through of a number 80 mesh sieve, preferably ranges from 90 to 99 percent pass-through, more preferably from 92 to 97 percent pass through.

The approximate composition of the preferred ADM Chick Pea Powder PCN 8920001 is listed in Table 1.

TABLE 1

| PARAMETER | WEIGHT PERCENT | |
|---|---|---|
| Moisture | 9.5 | (maximum) |
| Protein | 23.0 | |
| Fat | 7.0 | (maximum) |
| Carbohydrate | 64.0 | |
| Pass Through No. 80 Mesh Sieve | 95.0 | (minimum) |

The selection of a pre-gelled legume flour fora particular formulation is preferably determined empirically based on the desired effect to the rheological properties, texture, flavor profile, and mouth feel when the heat-treated legume flour is used in chocolate confections to replace the nonfat milk solids present in traditional milk chocolate.

Heat-treating the legume flour results in a dairy-free chocolate confection with a mouthfeel and melted texture similar to a traditional milk chocolate confection. Dairy-free chocolate confections using raw legume flour as a substitute for nonfat milk solids in traditional milk chocolate formulations have a claggy mouthfeel and a thick and highly viscous texture compared to melted chocolate in the mouth.

The heat treating allows for improved flavor development in the confection, inactivated certain enzymes and increases the shelf life of the flour. The relative quantity of legume flour used can vary depending on the rest of the formulation and desired final confection.

In an embodiment of a dairy-free chocolate confection where the sweetener is a nutritive sweetener, the heat-treated legume flour component comprises from 4 to 40 percent by weight of the confection. Preferably, the heat-treated legume flour component comprises from 8 to 25 percent, more preferably from 12 to 20 percent by weight of the confection.

Cocoa Component

Embodiments of the dairy-free chocolate confection may be made using any form of cocoa ingredients in any combination. Suitable cocoa components include natural coca solids, cocoa liquor, alkalized or dutched cocoa powder, other cocoa derived ingredients and combinations thereof. The cocoa component may be treated by fermentation and may be sourced from different origin cacao. In embodiments, preferred cocoa components comprise natural cocoa powder, cocoa liquor and combinations thereof.

In embodiments of a dairy-free chocolate confection formulation where the sweetener is a nutritive sweetener, the cocoa component comprises from 0 to 40 percent by weight of the chocolate confection, preferably from 10 to 35 percent by weight, more preferably from 15 to 30 percent by weight of the chocolate composition.

Sweetener

The dairy-free chocolate confection may be made using a wide variety of sweeteners. The sweetener may be a nutritive sweetener, a non-nutritive sweetener or combinations thereof. Suitable sweeteners include, but are not limited to: common sugars, including, but not limited to sucrose, fructose, glucose, corn syrup solids and the like; sugar alcohols including, but not limited to maltitol, sorbitol, erythritol and the like; rare sugars including, but not limited to Allulose, Tagatose and the like; and high intensity sweeteners, including, but not limited to aspartame, stevia and stevia extracts, sucralose and the like. A preferred sweetener is sucrose. In a preferred embodiment the sweetener comprises sweetener at least one from the group consisting of sugar alcohols, including, but not limited to, maltitol, sorbitol, erythritol, and rare sugars, including, but not limited to, allulose, tagatose, and intensity sweeteners, including, but not limited to, aspartame, stevia, stevia extracts, sucralose and combinations thereof. In embodiments of a dairy-free chocolate confection formulation where the sweetener is a nutritive sweetener, the sweetener comprises from 20 to 60 percent by weight of the confection, more preferably from 30 to 60 percent by weight, more preferably from 40 to 55 percent by weight of the dairy-free chocolate confection. In embodiments using high intensity sweeteners, the sweeteners will preferably comprise about 1 percent or less by weight of the confection and the balance of the mass of the confection will be made up by increasing the relative amounts of the other ingredients.

Plant Origin Fat

The plant origin fat is any fat not derived from an animal source. Preferred plant origin fats include, but are not limited to, cocoa butter, palm oil, palm kernel oil, coconut oil, shea butter, illepe fat, sal oil or any of their fractions or a combination thereof. The plant origin fat may include products marketed as Cocoa Butter Equivalents (CBE) and Milk Fat Replacers (MFR). A more preferred plant origin fat comprises cocoa butter. In an embodiment of a dairy-free chocolate confection, the plant origin fat comprises 10 to 40 percent by weight, preferably from 12 to 30 percent by weight, more preferably from 15 to 25 percent by weight of the dairy-free chocolate confection.

Other Optional Ingredients

Other optional ingredients in the dairy-free chocolate confection may include flavorings, salt, emulsifiers and other additives commonly used in the art. A preferred flavoring is natural vanillin. Optionally, inclusions, including but not limited to, nuts, dried fruits, puffed legumes, dairy-free cream fillings and combinations thereof may be used in the dairy-free chocolate confection.

Examples of suitable emulsifiers may be any of those typically used in the art and include, but are not limited to lecithin, polyglycerol polyricinoleate, ammonium phosphatide, or combinations thereof. The emulsifier is preferably present at a maximum level of 1% of any one emulsifier or any mixture of emulsifiers, although one of skill in the art will recognize that more or less emulsifier may be employed depending on the combination of fat and emulsifier used. A preferred emulsifier is lecithin.

In embodiments, the confection is free of emulsifiers such as polyglycerol polyricinoleate, and ammonium phosphatide. In an embodiment of a dairy-free chocolate confection where the sweetener is a nutritive sweetener, an emulsifier comprises from 0.01 to 1.0 percent by weight of the dairy-free chocolate confection, preferably between 0.15 and 0.75 percent by weight and more preferably from 0.25 to 0.60 percent by weight.

Method of Making a Dairy-Free Chocolate Confection

The dairy-free chocolate confection of the claimed invention may be prepared using methods similar to those used for traditional milk chocolate preparation but with non-dairy ingredients substituted for dairy ingredients. Referring to FIG. 2, in an embodiment, the heat-treated legume flour 130 is combined with the remaining dry ingredients (sweetener, cocoa component component) and approximately two-thirds of the plant origin fat 140 in a mixer 150. The heat-treated legume flour 130 may be obtained commercially or by treating a raw legume flour 110 with heat treating equipment 120. The mixture of dry ingredients and plant origin fat is refined 160 using any known refining method to yield a mean particle size of the heat-treated legume flour ranging from 5 to 45 microns, preferably 5 to 25 microns, more preferably 10 to 20 microns. After sufficient refining, the remaining one-third of the plant origin fat is added to the refined ingredients and mixed using a suitable mixing technique, at a temperature of approximately 50 degrees Celsius for a period of between 0.5 and up to 24 hours. The mixture is then cooled 170 to be tempered as needed and molded into desired confection molds 180.

In another embodiment, all of the ingredients (heat-treated legume flour component, sweetener, cocoa component and plant origin fat) are placed simultaneously into a mélange mixer and mixed for up to 24 hours to produce a dairy-free chocolate confection. Preferably the mélange mixer temperature is controllable set between 35 and 75 degrees Celsius, preferably between 40 and 70 degrees Celsius, more preferably between 45 and 60 degree Celsius.

In another embodiment, fat and nonfat solids ingredients are mixed in a ball mill to reduce the particle size of solids to a predetermined extent. The milled mix is than standardized to a composition and viscosity with the addition of fat and emulsifiers. The finished paste is then tempered as needed and applied to product by molding or enrobing.

The dairy-free chocolate confections of the present invention have superior taste, mouthfeel, texture, rheological properties and processability, as illustrated in the examples which follow. Without being bound to any particular theory, it is believed that physical and/or chemical changes that occur to the legume flour particles during the heat-treating process produce an ingredient that is a much more effective substitute for nonfat dairy solids in a traditional milk chocolate formulation than raw legume flour. Among the changes known to occur by roasting the legume flour are changes in the viscosity of the resulting chocolate compositions, changes in the particle size distribution of the legume flour in the resulting chocolate compositions and changes in the oil binding capacity of the legume flour. It is believed that these changes are responsible for the favorable results achieved using heat-treated legume flour as a substitute for dairy solids.

The following examples illustrate specific embodiments of the invention described in this disclosure. As would be apparent to skilled artisans, various changes and modifications are possible and are contemplated within the scope of the invention described. The following examples should not be construed, in any way, to limit the scope of the invention.

Example 1— Chocolate refining formulation made with pre-gelled chick pea flour.

A refining formulation for a chocolate confection was prepared according to the formulation of Table 2. This example is a preferred embodiment using a nutritive sweetener.

TABLE 2

| | Weight | Weight |
|---|---|---|
| Ingredient | (grams) | Percent |
| Pre-gelled Chick pea flour | 120.00 | 16.00 |
| (ADM PCN 892001 as per Table 1) | | |
| Sugar (sucrose) | 372.53 | 49.67 |
| Chocolate Liquor, Universal | 178.13 | 23.75 |
| CBE/MFR | 79.13 | 10.55 |
| Vanillin, USP Grade | 0.25 | 0.03 |
| Total | 750 | 100 |

The ingredients were combined in a three roll refiner and conched at 55 degrees Celsius for two hours.

Example 2— Finished chocolate made with pre-gelled chick pea flour.

A refining formulation was prepared according to Example 1 and combined with the standardizing formulation as shown in Table 3 to produce a finished chocolate.

TABLE 3

| | Weight | Weight |
|---|---|---|
| Ingredient | (grams) | Percent |
| Refined material from Example 1 | 730.08 | 91.26 |
| CBE/MFR | 65.20 | 8.15 |
| Stevia RA 80 | 0.16 | 0.02 |
| Lecithin, Soy, Unbleached, Test Free | 3.20 | 0.40 |
| Polyglycerol polyricinoleate (PGPR) | 1.36 | 0.17 |
| Total | 800 | 100 |

1. A chocolate confection comprising:
a heat-treated legume flour component;
a cocoa component;
a sweetener; and
a plant origin fat.

2. The chocolate confection of claim 1, wherein the chocolate confection is dairy-free.

3. The chocolate confection of claim 1, wherein the heat-treated legume flour component comprises a legume flour selected from the group consisting of beans, peas, chickpeas, and combinations thereof.

4. The chocolate confection of claim 1, wherein the cocoa component is selected from the group consisting of cocoa solids, cocoa powder, cocoa liquor, and combinations thereof.

5. The chocolate confection of claim 1, wherein the sweetener is a nutritive sweetener selected from the group consisting of sucrose, fructose, glucose, corn syrup solids, and combinations thereof.

6. The chocolate confection of claim 1, wherein the sweetener comprises a sweetener selected from the group consisting of sugar alcohols, rare sugars, intensity sweeteners, and combinations thereof.

7. The chocolate confection of claim 1, wherein the plant origin fat is selected from the group consisting of cocoa butter, palm oil, palm kernel oil, sunflower oil, shea, sal, illepe, coconut, and combinations thereof.

8. The chocolate confection of claim 1, wherein the heat-treated legume flour component is selected from the group consisting of chickpeas, navy beans, and combinations thereof.

9. The chocolate confection of claim 1, wherein the heat-treated legume flour component comprises less than 5 percent by weight of water.

10. The chocolate confection of claim 1, wherein the sweetener is a nutritive sweetener and the heat-treated legume flour component comprises from 4 to percent by weight of the chocolate confection.

11. (canceled)

12. The chocolate confection of claim 1 wherein the sweetener comprises from 20 to 60 percent by weight of the chocolate confection.

13. The chocolate confection of claim 1 wherein the plant origin fat comprises from 10 to 40 percent by weight of the chocolate confection.

14. The chocolate confection of claim 1, wherein the cocoa component comprises from 15 to 40 percent by weight of the chocolate confection.

15. The chocolate confection of claim 1, wherein the heat-treated legume flour component comprises from 12 to 20 percent by weight of the chocolate confection.

16. (canceled)

17. (canceled)

18. (canceled)

19. A method of making a dairy-free chocolate confection comprising:
a. providing a heat-treated legume flour component; and
b. mixing and grinding a desired amount of the heat-treated legume flour component with a desired amount of a sweetener, a desired amount of a cocoa component, and a desired amount of a plant origin fat, a plant-origin fat to produce a dairy-free chocolate confection.

20. The method of claim 19, wherein step b comprises mixing and grinding the heat-treated legume flour component in an amount of from 12 to 20 percent by weight of the chocolate confection.

21. The method of claim 19, wherein step b comprises mixing and grinding the sweetener in an amount of from 40 to 55 percent by weight of the chocolate confection.

22. The method of claim 19, wherein step b comprises mixing and grinding the cocoa component in an amount of from 15 to 30 percent by weight of the chocolate confection.

23. The method of claim 19, wherein step b comprises mixing and grinding the plant origin fat in an amount of from 15 to 25 percent of the chocolate confection.

24. The method of claim 19, wherein step b comprises mixing and grinding the heat-treated legume flour with the sweetener, the cocoa component, and the plant origin fat until a target particle size of the heat-treated legume flour component is obtained.
